(19) United States
(12) Patent Application Publication
(10) Pub. No.: US 2012/0044053 A1
(43) Pub. Date: Feb. 23, 2012

(54) APPARATUS AND METHOD FOR IMPROVING RECEPTION SENSITIVITY OF RFID READER

(75) Inventors: Jae Young JUNG, Daejeon (KR); Dong Han LEE, Daejeon (KR); Kwang Soo CHO, Daejeon (KR); Chan Won PARK, Daejeon (KR)

(73) Assignee: Electronics and Telecommunications Research Institute, Daejeon (KR)

(21) Appl. No.: 13/015,030

(22) Filed: Jan. 27, 2011

(30) Foreign Application Priority Data
Aug. 23, 2010 (KR) 10-2010-0081456

(51) Int. Cl. G06K 7/01

(52) U.S. Cl. 340/10.1

(57) ABSTRACT

An apparatus and method for improving reception sensitivity of a radio frequency identification (RFID) reader are disclosed. The apparatus includes a branch unit to separate an input signal into a first signal and a second signal; a first processing unit to convert a phase of the first signal; a second processing unit to extract a leakage signal from the second signal; and a control unit to output a tag response signal from the input signal using the converted first signal and the extracted leakage signal.

### CROSS-REFERENCE TO RELATED APPLICATION

This application claims the benefit of Korean Patent Application No. 10-2010-0081456, filed on Aug. 23, 2010, in the Korean Intellectual Property Office, the disclosure of which is incorporated herein by reference.

### BACKGROUND

1. Field of the Invention

The present invention relates to an apparatus and method for improving reception sensitivity of a radio frequency identification (RFID) reader and accordingly improving a reading distance and reading performance of the RFID reader, by suppressing a leakage signal from an input signal and efficiently outputting a tag response signal.

2. Description of the Related Art

Generally, according to a radio frequency identification (RFID) scheme, a tag is attached to each object and a specific identity (ID) of the object is wirelessly recognized. Accordingly, information on the object can be collected, stored, processed, and tracked. Thus, the RFID technology may provide services including location, remote processing, and management of an object, and information exchange between objects. The RFID technology is expected to replace a conventional barcode scheme and establish a new market in various fields such as management and distribution of materials in addition to security.

An RFID system using an ultrahigh frequency (UHF) of about 900 MHz is a passive type and uses backscattering modulation for data transmission. According to the backscattering modulation, when a tag receives continuous waves (CW) transmitted from a reader and transmits the received CW to the reader by scattering the CW, information of a tag is transmitted by conversion of an amplitude of the scattered waves.

Hereinafter, a conventional RFID system will be described with reference to FIG. 1.

FIG. 1 is a diagram illustrating a structure of the conventional RFID system.

Referring to FIG. 1, the RFID system performs communication based on the UHF band of 900 MHz and includes an RFID reader 100 and an RFID tag 130.

The RFID reader 100 includes a reader transmitter 101, a reader receiver 111, and a modulation/demodulation frequency generator 121.

The reader transmitter 101 includes a digital-analog (D/A) converter 102 that converts a reader command signal in a digital form into an analog signal, a low pass filter 103, a modulator 104 that upwardly modulates the converted analog signal into a wireless frequency signal, a drive amplifier 105 that increases a gain to supply sufficient energy to the tag, a power amplifier 106, a band pass filter 107, and a transmission antenna 108.

The reader receiver 111 may include a reception antenna 112, a band pass filter 113 that suppresses noise of a tag response signal received from the RFID tag 130, a low noise amplifier 114, a demodulator 115 that converts the received tag response signal into a baseband signal, a baseband filter 116, a baseband amplifier 117, and an A/D converter 118 that converts an analog signal into a digital signal.

The modulation/demodulation frequency generator 121 generates frequencies to be input to the modulator 104 and the demodulator 115.

In accordance with the RFID system communication protocol, when receiving a baseband signal from a digital unit, for example, a modem, the reader transmitter 101 alternately transmits a modulation signal and a CW signal to the RFID tag 130. When the reader transmitter 101 transmits the modulation signal, the RFID tag 130 only receives the modulation signal without transmitting a tag response signal related to the modulation signal to the RFID reader 100. Therefore, the RFID reader 100 receives no signal from the RFID reader 100. However, when the reader transmitter 101 transmits the CW signal, the RFID tag 130 transmits the tag response signal to the RFID reader 100. Accordingly, the reader receiver 111 receives and processes the tag response signal.

In other words, the RFID tag 130 partially absorbs the CW signal received from the RFID reader 100 and partially reflects the CW signal. That is, the signal reflected from the RFID tag 130 is the tag response signal from the RFID tag 130. Since the reflectance is varied, tag information is loaded on the reflected signal.

In addition, the RFID reader 100 simultaneously receives and transmits the CW signal. To simultaneously receive and transmit the CW signal, the RFID reader 100 uses the same frequency both for transmission and reception. Here, a frequency division duplex (FDD) method or a switch-type method cannot be applied. Also, the transmission antenna and the reception antenna are to be separated from each other to secure isolation between the transmission and the reception. Alternatively, the transmission and the reception antennas are integrated by a circulator or a directional coupler.

The RFID reader 100 uses separate transmission and reception antennas, that is, the transmission antenna 108 and the reception antenna 112, to secure desired isolation between transmission and reception. However, here, a distance between the transmission antenna 108 and the reception antenna 112 cannot be increased as desired due to response characteristics of the RFID tag 130. Therefore, the isolation is deteriorated by signal coupling in a space. In addition, patterns of the antennas 108 and 112 are varied according to the surroundings of the antennas, which may cause a coupling of transmission signals and reception signals and thereby deteriorate the isolation.

Since the isolation is insufficient in the RFID reader 100, part of the transmission signals may leak and flow into the reader receiver 111 of the RFID reader 100. Here, the reader receiver 111 receives the leakage signal leaked from the leader receiver 101 together with a backscattered signal, that is, the tag response signal reflected from the RFID tag 130.

Accordingly, there is a desire for a technology enabling extraction of a tag response signal reflected from an RFID tag from an input signal input to a receiver of a reader, and easily restoring modulation signal components including tag information from the tag response signal.

### SUMMARY

An aspect of the present invention provides an apparatus and method for improving a reading distance and reading performance of a reader, by suppressing a leakage signal from an input signal and easily outputting a tag response signal.

According to an aspect of the present invention, there is provided an apparatus for improving reception sensitivity of a radio frequency identification (RFID) reader, the apparatus including a branch unit to separate an input signal into a first signal and a second signal, a first processing unit to convert a phase of the first signal, a second processing unit to extract a leakage signal from the second signal, and a control unit to output a tag response signal from the input signal using the converted first signal and the extracted leakage signal.

According to another aspect of the present invention, there is provided a method for improving reception sensitivity of an RFID reader, the method including separating an input signal into a first signal and a second signal, converting a phase of the first signal, extracting a leakage signal from the second signal, and outputting a tag response signal from the input signal using the converted first signal and the extracted leakage signal.

### Effect

According to embodiments of the present invention, a reading distance and reading performance of a reader may be increased by suppressing a leakage signal from an input signal and easily outputting a tag response signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a conventional radio frequency identification (RFID) system;

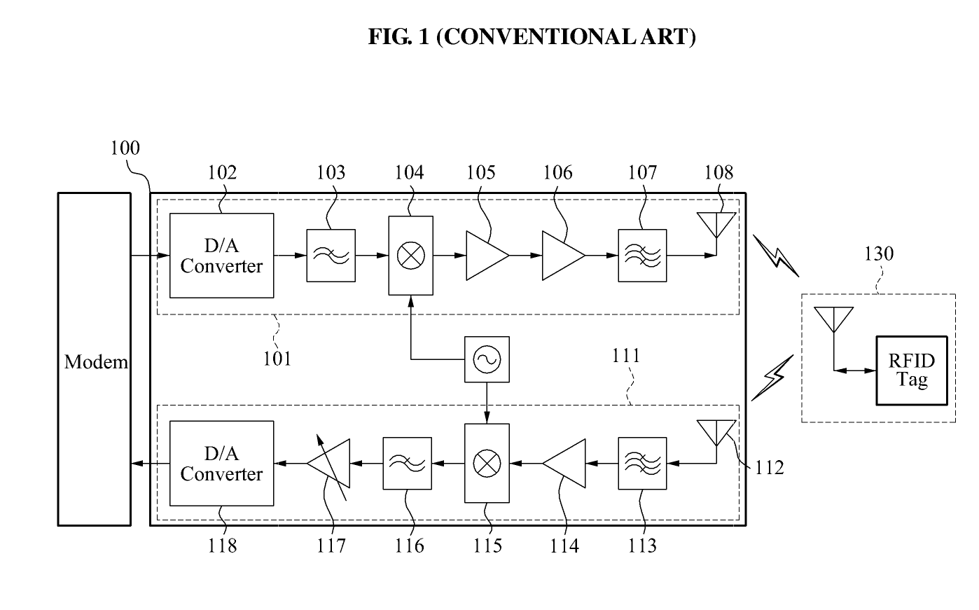

FIG. 2 is a diagram illustrating an RFID reader with a reception sensitivity improving apparatus, according to an embodiment of the present invention;

FIG. 3 is a diagram illustrating an RFID reader with a reception sensitivity improving apparatus, according to another embodiment of the present invention;

FIG. 4 is a diagram illustrating a structure of a reception sensitivity improving apparatus for an RFID reader, according to an embodiment of the present invention;

FIG. 5 is a diagram illustrating a structure of a reception sensitivity improving apparatus for an RFID reader, according to another embodiment of the present invention;

FIG. 6 is a diagram illustrating a structure of a reception sensitivity improving apparatus for an RFID reader, according to still another embodiment of the present invention; and

FIG. 7 is a flowchart illustrating a method of improving reception sensitivity of an RFID reader, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

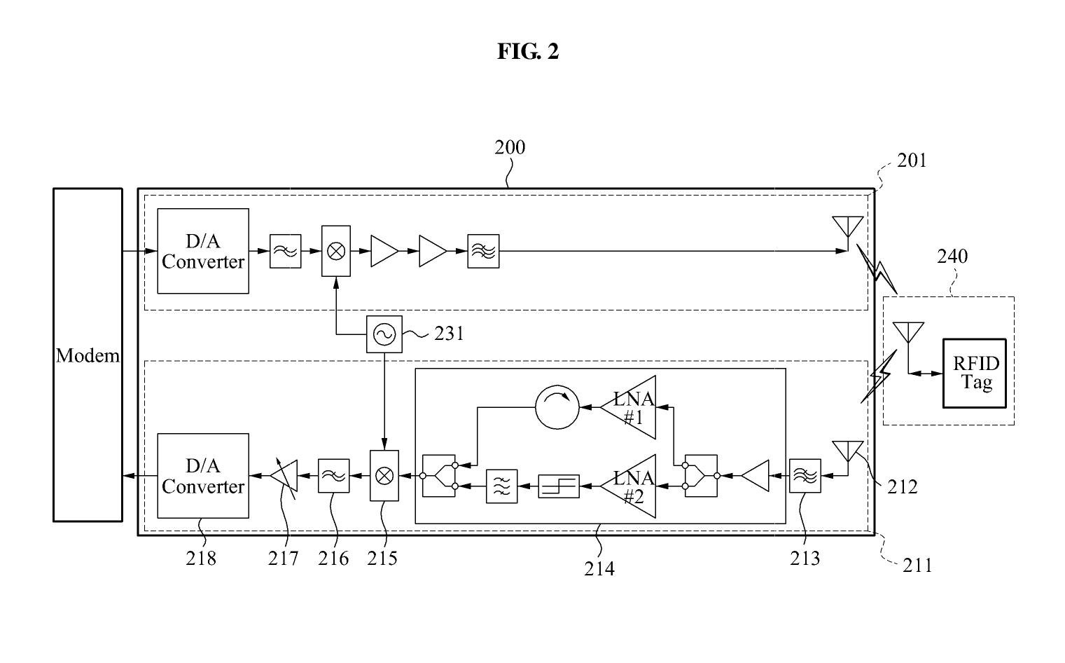

FIG. 2 is a diagram illustrating a radio frequency identification (RFID) reader 200 including a reception sensitivity improving apparatus, according to an embodiment of the present invention.

Referring to FIG. 2, the RFID reader 200 includes a reader transmitter 201, a reader receiver 211, and a modulation/demodulation frequency generator 231.

Upon receiving a baseband signal from a modem, the reader transmitter 201 transmits a modulation signal and a continuous wave (CW) signal, alternately, to an RFID tag 240.

Specifically, the reader transmitter 201 may include a digital/analog (D/A) converter 202 adapted to convert a reader command signal in a digital form into an analog signal, a low pass filter 203, a modulator 204 adapted to upwardly convert the analog signal into a wireless frequency signal, a drive amplifier 205 adapted to increase a gain to supply sufficient energy to a tag, a power amplifier 206, a band pass filter 207, and a transmission antenna 208.

The reader receiver 211 may receive a tag response signal from the RFID tag 240 when the reader transmitter 201 transmits the CW signal. The reader receiver 211 may further receive a leakage signal leaked from the reader transmitter 201 along with the tag response signal from the RFID tag 240.

More specifically, the reader receiver 211 may include a reception antenna 212, a baseband pass filter 213 adapted to suppress noise of the tag response signal received from the RFID tag 240, a reception sensitivity improving apparatus 214, a demodulator 215 adapted to convert the received tag response signal into a baseband signal, a baseband filter 216, a baseband amplifier 217, and an A/D converter 218 adapted to convert an analog signal into a digital signal.

The modulation/demodulation frequency generator 231 may generate frequencies to be input to the modulator 204 and the demodulator 215.

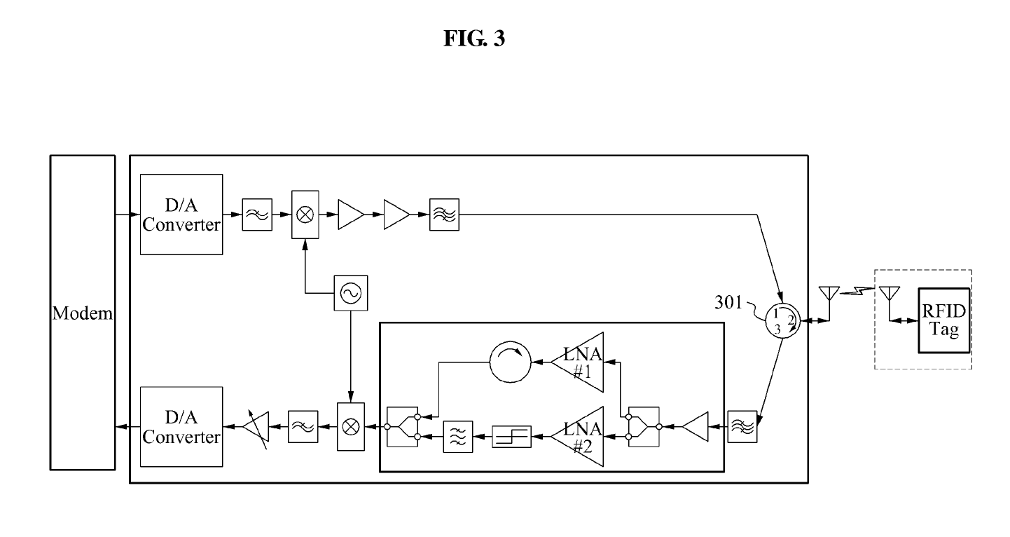

Referring to FIG. 3, an RFID reader including a reception sensitivity improving apparatus according to another embodiment may include an integrated antenna instead of the transmission antenna and the reception antenna. Here, the RFID reader including the reception sensitivity improving apparatus may easily separate a signal transmitted from the reader transmitter and a signal input to the reader receiver by a circulator 301 connected with the reader transmitter, the reader receiver, and the integrated antenna.

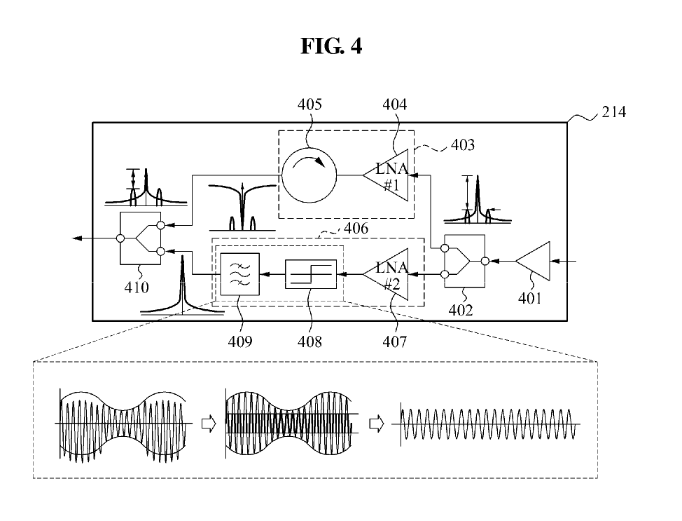

FIG. 4 is a diagram illustrating a structure of a reception sensitivity improving apparatus 214 for an RFID reader, according to an embodiment of the present invention.

Referring to FIGS. 2 and 4, the reception sensitivity improving apparatus 214 may include an automatic gain adjustment unit 401, a branch unit 402, a first processing unit 403, a second processing unit 406, and a control unit 410.

The automated gain adjustment unit 401 may adjust a gain of a noise-suppressed signal of a tag response signal, through the baseband filter 213.

The branch unit 402 may receive the tag response signal of which the gain is adjusted by the automated gain adjustment unit 401, as an input signal, and separate the input signal into a first signal and a second signal. Here, the input signal may be separated into the first signal and the second signal which are identical to each other.

The branch unit 402 may be a 3-port device including one input port and two output ports, for example, a half power distributor. However, the branch unit 402 is not limited thereto, and a power distributor with a different rate may be applied.

The first processing unit 403 may convert a phase of the first signal. The first processing unit 403 may include a first amplitude adjustor 404 adapted to adjust an amplitude of the first signal, and a phase shifter 405 adapted to invert the phase of the first signal of which an amplitude is adjusted. For example, the first processing unit 403 may amplify the first signal and convert the phase of the amplified first signal by about 180 degrees.

The second processing unit 406 may extract a leakage signal from the second signal. Here, the second processing unit 406 may include a second amplitude adjustor 407 adapted to adjust an amplitude of the second signal, a limiter 408 adapted to limit the adjusted amplitude of the second signal, and a wave filter 409 adapted to remove a high-frequency signal from the limited second signal and thereby extract the leakage signal.

Here, the second amplitude adjustor 407 may adjust the amplitude of the second signal in consideration of the amplitude of the first signal output from the first processing unit 403. For example, the second amplitude adjustor 407 may adjust the amplitude of the second signal to be equal to the amplitude of the first signal output from the first processing unit 403.

The limiter 408 may control the amplitude of the second signal output from the second amplitude adjustor 407 to be within a designated allowable range. Accordingly, modulators of the signal passed through the limiter 408 are removed whereas only a fundamental wave signal and a high-frequency signal with respect to a carrier signal of the leakage signal remain.

The wave filter 409 may pass only the fundamental wave signal of the carrier signal of the leakage signal while removing the high-frequency signal. As a result, only pure carrier components of the leakage signal remain.

The control unit 410 may output the tag response signal from the input signal using the converted first signal and the extracted leakage signal. For example, the control unit 410 may be in the form of a combiner which combines two signals to output one signal, such as a 3-port device including one input port and two output ports. The first signal output from the first processing unit 403 and the second signal output from the second processing unit 406 may be combined and output as the tag response signal.

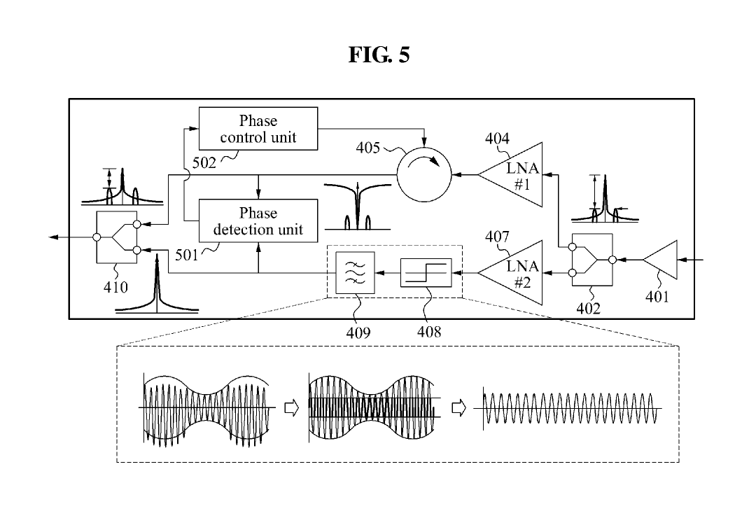

FIG. 5 is a diagram illustrating a structure of a reception sensitivity improving apparatus for an RFID reader, according to another embodiment of the present invention.

Referring to FIG. 5, since the reception sensitivity improving apparatus of the present embodiment has significantly the same structure as the reception sensitivity improving apparatus of FIG. 4, redundant descriptions thereof will be omitted.

However, the reception sensitivity improving apparatus of the present embodiment may further include a phase detection unit 501 adapted to detect a phase difference between the first signal and the second signal, and a phase control unit 502 adapted to control a phase change of the phase shifter 405.

Here, the phase detection unit 501 may detect the phase difference between the first signal converted by the first processing unit 403 and the leakage signal extracted from the second processing unit 406.

When the phase difference detected by the phase detection unit 501 is beyond a predetermined reference range fails to satisfy a reference value, the phase control unit 502 may transmit a feedback signal to the phase shifter 405 of the first processing unit 403 so that the phase change of the first signal is controlled by the phase shifter 405 of the first processing unit 405.

Here, the phase control unit 502 may transmit the feedback signal to the phase shifter 405 such that the phase difference between the first signal converted by the first processing unit 403 and the leakage signal extracted by the second processing unit 406 is maintained to be about 180 degrees.

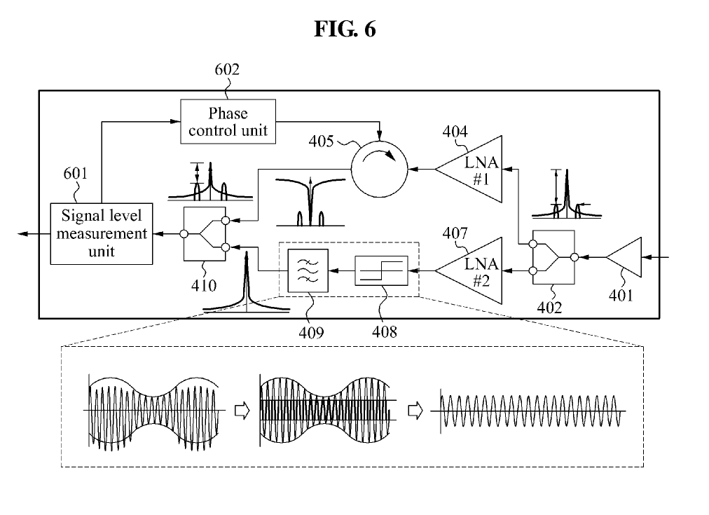

FIG. 6 is a diagram illustrating a structure of a reception sensitivity improving apparatus for an RFID reader, according to still another embodiment of the present invention.

Referring to FIG. 6, the reception sensitivity improving apparatus of the present embodiment has significantly the same structure as the reception sensitivity improving apparatus of FIG. 5 and thus, redundant descriptions thereof will be omitted.

The reception sensitivity improving apparatus of the present embodiment may include a signal level measurement unit 601 adapted to measure a level of a signal output from the control unit 410, instead of the phase detection unit.

When the signal level measured by the signal level measurement unit 601 is beyond a predetermined reference range, a phase control unit 602 may transmit a feedback signal to the first processing unit 403 such that the degree of phase change of the first signal is controlled by the first processing unit 403.

That is, the reception sensitivity improving apparatus according to the present embodiment controls the degree of phase change of the first signal based on the phase difference between the first signal and the second signal or based on the level of a combined signal of the first signal and the second signal. Accordingly, the leakage signals included respectively in the first signal and the second signal are offset. As a result, the tag response signal may be efficiently output from the input signal input to the reception sensitivity improving apparatus.

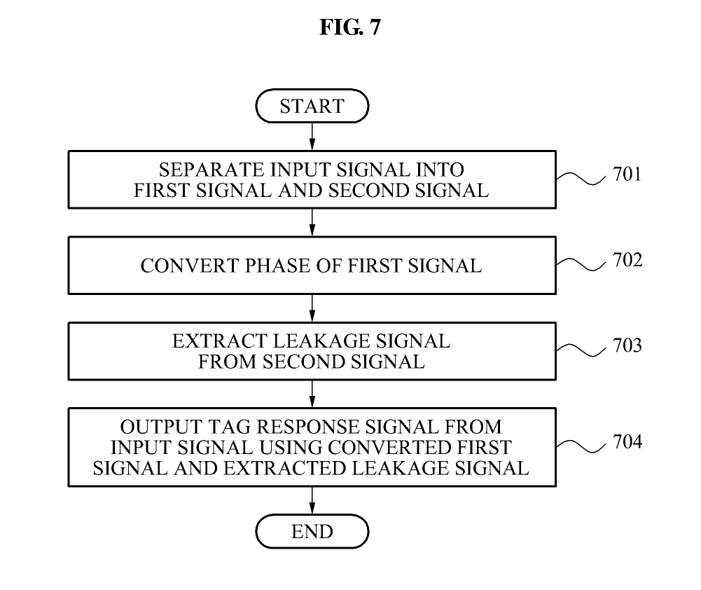

FIG. 7 is a flowchart illustrating a method of improving reception sensitivity of an RFID reader, according to an embodiment of the present invention.

Referring to FIG. 7, in operation 701, a reception sensitivity improving apparatus is input with a leakage signal leaking from an RFID reader along with a tag response signal from an RFID tag. In addition, the reception sensitivity improving apparatus separates the input signal into a first signal and a second signal.

Here, the first and the second signals separated from the input signal may be identical with each other.

In operation 702, the reception sensitivity improving apparatus converts a phase of the first signal.

More specifically, the reception sensitivity improving apparatus may adjust amplitude of the first signal and invert the phase of the amplitude-adjusted first signal.

In operation 703, the reception sensitivity improving apparatus extracts the leakage signal from the second signal.

More specifically, the reception sensitivity improving apparatus may extract the leakage signal by adjusting amplitude of the second signal, limiting the amplitude of the amplitude-adjusted second signal, and removing a high-frequency signal from the amplitude-limited second signal.

In operation 704, the reception sensitivity improving apparatus outputs the tag response signal from the input signal using the converted first signal and the extracted leakage signal.

For example, the reception sensitivity improving apparatus may combine the converted first signal and the extracted leakage signal, thereby offsetting the phase-inverted leakage signal included in the first signal with the extracted leakage signal, and output the tag response signal included in the first signal.

In operation 703 described above, the reception sensitivity improving apparatus may detect the phase difference between the converted first signal and the extracted leakage signal and, when the detected phase difference is beyond a predetermined reference range, may adjust a degree of phase change with respect to the first signal.

Additionally, in operation 704 described above, the reception sensitivity improving apparatus may measure a level of the signal output from the input signal, that is, the tag response signal. When the measured level is beyond a predetermined reference range, the reception sensitivity improving apparatus may adjust the phase change degree of the first signal.

According to the embodiments of the present invention, a leakage signal is suppressed from an input signal while a tag response signal is efficiently output. As a consequence, a reading distance and reading performance of a reader may be increased.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for improving reception sensitivity of a radio frequency identification (RFID) reader, the apparatus comprising:
a branch unit to separate an input signal into a first signal and a second signal;
a first processing unit to convert a phase of the first signal;
a second processing unit to extract a leakage signal from the second signal; and
a control unit to output a tag response signal from the input signal using the converted first signal and the extracted leakage signal.

2. The apparatus of claim 1, wherein the first processing unit comprises a phase shifter to invert the phase of the first signal.

3. The apparatus of claim 1, wherein the second processing unit comprises:
a limiter to limit an amplitude of the second signal; and
a wave filter to remove a high-frequency signal from the amplitude-limited second signal and thereby extract the leakage signal.

4. The apparatus of claim 1, further comprising:
a phase detection unit to detect a phase difference between the converted first signal and the extracted leakage signal; and
a phase control unit to control the first processing unit to adjust a phase change degree of the first signal by transmitting a feedback signal to the first processing unit when the detected phase difference is beyond a predetermined reference range.

5. The apparatus of claim 1, further comprising:
a signal level measurement unit to measure a level of the output tag response signal; and
a phase control unit to control the first processing unit to adjust a degree of the phase change of the first signal by transmitting a feedback signal to the first processing unit when the measured level is beyond a predetermined reference range.

6. A method for improving reception sensitivity of an RFID reader, the method comprising:
separating an input signal into a first signal and a second signal;
converting a phase of the first signal;
extracting a leakage signal from the second signal; and
outputting a tag response signal from the input signal using the converted first signal and the extracted leakage signal.

7. The method of claim 6, wherein the converting of the phase of the first signal comprises inverting the phase of the first signal.

8. The method of claim 6, wherein the outputting of the leakage signal from the second signal comprises:
limiting amplitude of the second signal; and
removing a high-frequency signal from the amplitude-limited second signal and thereby extracting the leakage signal.

9. The method of claim 6, further comprising:
detecting a phase difference between the converted first signal and the extracted leakage signal; and
adjusting a phase change degree of the first signal when the detected phase difference is beyond a predetermined reference range.

10. The method of claim 6, further comprising:
measuring a level of the output tag response signal; and
adjusting a phase change degree of the first signal when the measured level is beyond a predetermined reference range.
